(19) United States
(12) Patent Application Publication
(10) Pub. No.: US 2012/0286483 A1
(43) Pub. Date: Nov. 15, 2012

(54) HAND TRUCK WITH LIFTING MECHANISM

(76) Inventor: Marcel Fluet-Howrish, Edmonton (CA)

(21) Appl. No.: 13/105,805

(22) Filed: May 11, 2011

(51) Int. Cl. B62B 5/02

(52) U.S. Cl. 280/5.3

(57) ABSTRACT

A hand truck with a lifting mechanism has a frame having a handle portion, and a load-carrying portion. An axle is supported by the frame and has wheels rotatably mounted to opposed ends of the axle. An extendible member is pivotally mounted to the axle. The extendible member comprises a housing and an extendible portion that extends from the housing. The extendible portion has an engagement end, the engagement end retracting within an outer perimeter of the wheels in a retracted position, and extending outward to engage a ground surface. In the extended position, the extendible member has a length that is greater than a diameter of the wheels. A control mechanism selectively extends and retracts the extendible portion.

### FIELD

This relates to a hand truck used to move large or heavy objects, such as furniture, appliances, etc., and is intended to be used specifically when stairs are encountered.

### BACKGROUND

Often, a hand truck is used when moving large or heavy objects, which can be awkward or dangerous to move otherwise. However, using the hand truck loaded with the object may be difficult when stairs are encountered. U.S. Pat. No. 3,494,440 (Hanson) entitled “Device for moving heavy objects up and down stairs” describes a hand truck with an extendible support member used to move up and down stairs.

### SUMMARY

There is provided a hand truck with a lifting mechanism, comprising a frame having a handle portion, and a load-carrying portion. An axle supported by the frame, the axle having wheels rotatably mounted to opposed ends of the axle. An extendible member is pivotally mounted to the axle, the extendible member comprising a housing and an extendible portion that extends from the housing. The extendible portion has an engagement end, the engagement end retracting within an outer perimeter of the wheels in a retracted position, and extending outward to engage a ground surface. In the extended position, the extendible member having a length that is greater than a diameter of the wheels. A control mechanism selectively extends and retracts the extendible portion.

According to another aspect, the housing of the extendible member may be attached to the axle at a midpoint of the housing, such that the housing extends past the axle in two directions.

According other aspects, the extendible member may be screw-actuated and the control mechanism is a rotating body. The control mechanism may be pivotally connected to the extendible member. The control mechanism may be pivotally connected to the extendible member by a knuckle joint. The control mechanism may comprise a hand-operated portion adjacent to the handle portion of the frame, an attachment for a drill, or both. The control mechanism may be secured to the frame using a bracket that permits axial movement of the control mechanism relative to the frame.

According to another aspect, the extendible end may comprise an angled surface, such that the extendible member applies a lifting force that has vertical and horizontal components. There may be a spring member that biases extendible member toward a predetermined position.

According to another aspect, the extendible end may be wider than a width of the extendible member.

According to another aspect, the extendible member may be longer than a diameter of the wheels.

According to another aspect, there is provided a lifting mechanism for a hand truck having a frame, an axle, and wheels attached to the axle. The lifting mechanism comprises an extendible member comprising a housing and an extendible portion that extends from the housing. The extendible portion has an engagement end. The extendible member has a retracted position and an extended position. A pivoting axle clamp is attached to a midpoint of the housing for attaching to the axle of the hand truck. The distance between the midpoint and the engagement end of the extendible portion in the retracted position is less than a radius of the wheels of the hand truck. The extendible member has a length that is greater than a diameter of the wheels. A control mechanism selectively extends and retracts the extendible portion.

According other aspects, the extendible member may be a screw-actuated and the control mechanism is a rotating body. The control mechanism may be pivotally connected to the extendible member. The control mechanism may be pivotally connected to the extendible member by a knuckle joint. The control mechanism may comprise a hand-operated portion, or an attachment for a drill. There may be a bracket for attaching the control mechanism to a frame of the hand truck that permits axial movement of the control mechanism relative to the frame.

According to another aspect, the extendible end comprises an angled surface, such that the extendible member applies a lifting force that has vertical and horizontal components. There may be a spring member that biases extendible member toward a predetermined position.

According to another aspect, the extendible end may be wider than a width of the extendible member.

According to another aspect, the extendible member may be longer than a diameter of the wheels.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a detailed rear perspective view of the bottom of a hand truck

FIG. 2 is a side elevation view in section of an extendible member.

FIGS. 3 through 6 are side elevation views of the hand truck mounting stairs at various stages.

FIG. 7 is a side elevation view showing a variation of the control mechanism.

### DETAILED DESCRIPTION

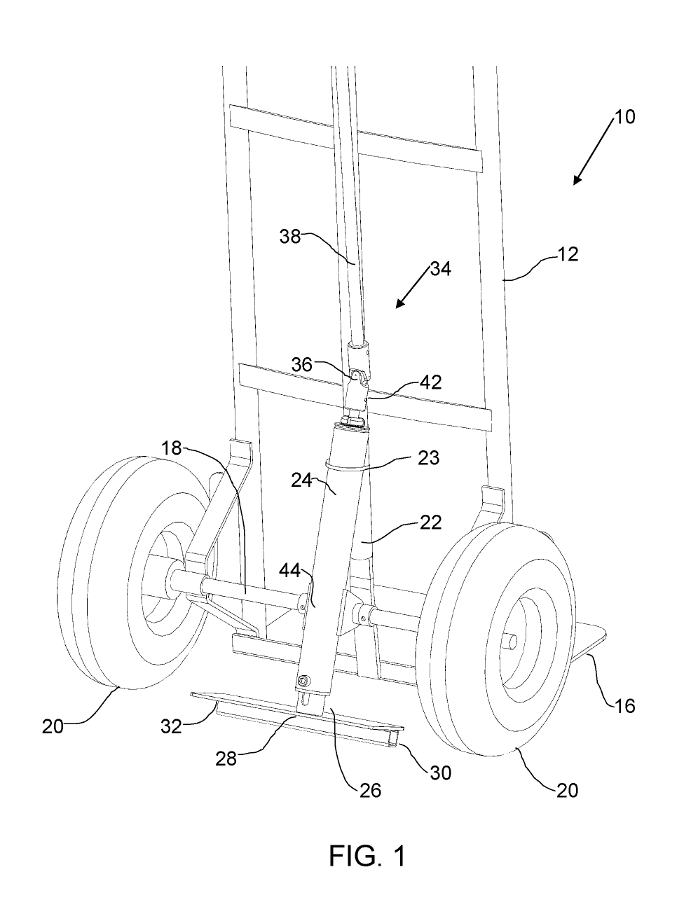

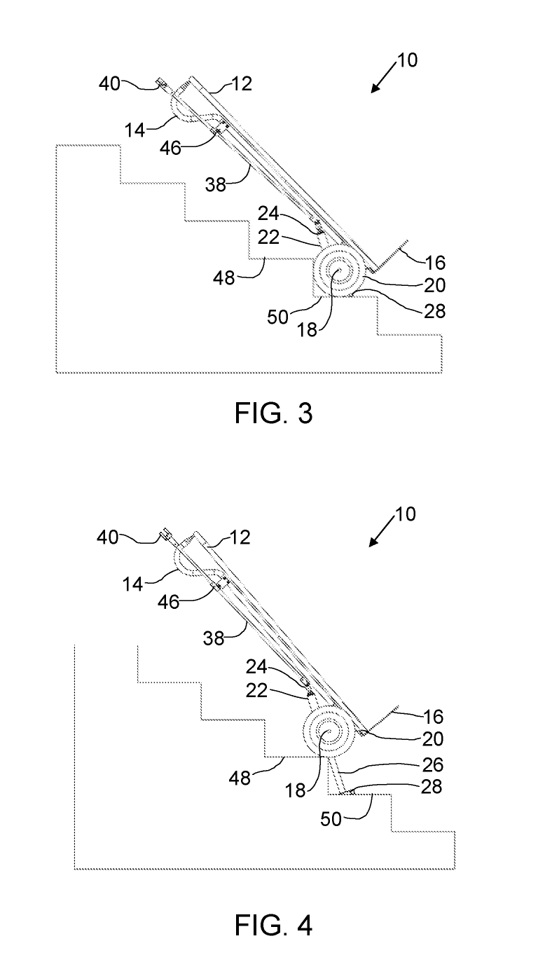

Referring to FIGS. 1 and 3, a hand truck, generally identified by reference numeral 10, has a frame 12 with a handle portion 14, and a load-carrying portion 16. Different types of hand truck are in use. The types of hand trucks of concern herein are generally two-wheeled, and are vertically oriented, rather than hand truck with a flat surface supported by four wheels. Older styles of hand trucks, such as the hand truck described in U.S. Pat. No. 3,713,501, often have smaller wheels. The preferred embodiment described herein and depicted in the drawings uses a style of hand truck with larger wheels. Hand truck 10 may have multiple positions for a user's hand, such as a place for a two-handed grip, or a one-handed grip as shown. Load-carrying portion 16 is preferably a protruding, flat, relatively narrow shelf that is placed flat against a ground surface when frame 12 is vertically oriented, and lifts loads off the ground as it is angled backward.

Hand truck 10 has an axle 18 that is supported by frame 12 with wheels 20 rotatably mounted to opposed ends of the axle 18. There is an extendible member 22 that is pivotally mounted to axle 18. A spring member 23 is used to bias extendible member into the position shown in FIG. 1. Other types of spring members 23 and spring members 23 in different locations, may be used, as will be recognized by those skilled in the art. Extendible member 22 is made up of a housing 24 and an extendible portion 26 that extends from housing 24. As shown, extendible member is a screw-actuated lifting cylinder, where extendible portion 26 extends from or retracts into housing 24 based on rotation of a control element. While this is the preferred embodiment based considerations such as cost, reliability, etc., it will be apparent to those skilled in the art that other lifting mechanism designs may also be used, such as a hydraulically or electrically powered lifting device. Extendible portion 26 has an engagement end 28 that retracts within an outer perimeter of the wheels 20 in a retracted position, and that extends outward to engage a ground surface in the extended position. Extendible portion 26 extends to a length that is greater than the radius of wheels 20, and preferably much further. The actual extension will depend on the type of obstacles that will be encountered, and how far engagement end 28 retracts relative to the outer surface of wheels 20. Preferably, as the maximum height of a stair is about 8 inches, extendible portion 26 preferably extends between 8 and 10 inches beyond the outer surface of wheels 20, or in other words, 8 to 10 inches beyond the initial extension required for the engagement end 28 to reach the outer surface of wheels 20. Other extension lengths may be selected based on the preferences of the user. However, extendible member 22 is longer in the retracted position than a diameter of wheels 20.

As depicted, engagement end 28 is preferably angled relative to extendible member 22, such that the force applied to engagement end 28 as extendible member 22 extends is up and back. As shown in FIGS. 3 and 4, this helps promote stability by pressing wheels 20 back onto the stair above. In the depicted embodiment, this is achieved by attaching a length of square tubing 30 to a flat foot 32, resulting in an angle. Other designs for achieving an angle may also be used, as will be recognized by those skilled in the art. The width of engagement end 28 is preferably wide enough to provide stability to hand truck 10 as it lifts a load off the ground. Engagement end 28 may also have a non-slip surface to provide better traction while lifting a load.

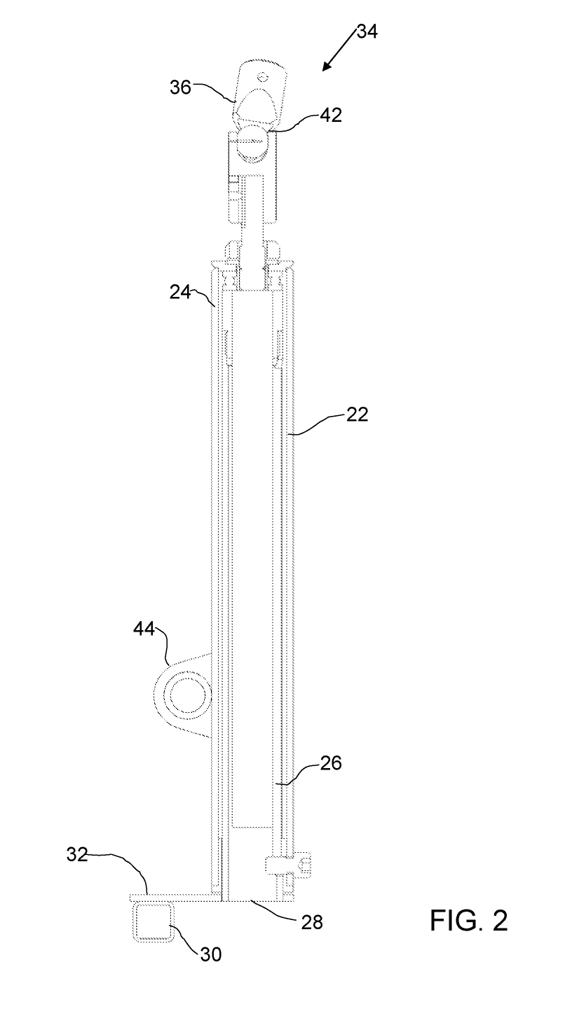

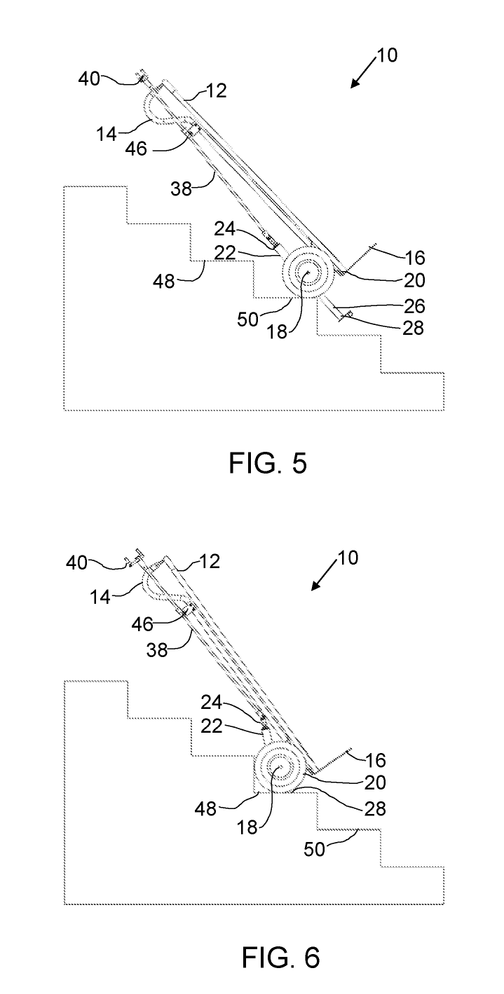

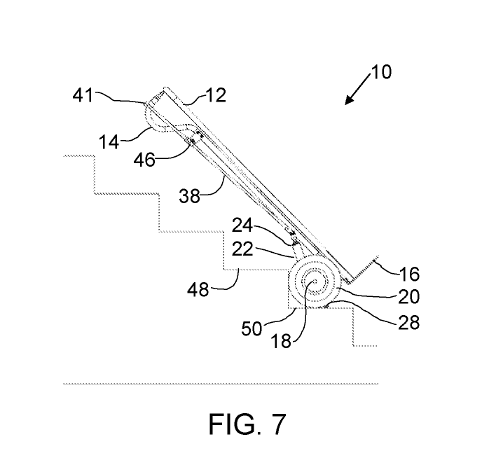

As mentioned above, extendible member 22 is preferably a screw-actuated lifting cylinder. Referring to FIG. 2, extendible member 22 is controlled by a control mechanism 34 that rotates to selectively extend and retract extendible portion 26, depending on the direction of rotation. In the depicted example, referring to FIG. 1, control mechanism 34 is made up of a rod coupling 36 attached to a rod 38 that extends along frame 12 to a hand-operated handle 40 as shown in FIGS. 3 through 6, which is conveniently located adjacent to handle portion 14 of frame 12. Referring to FIG. 7, handle 40 may be mounted to rod 38 by an attachment 41 secured to the top of rod 38. Attachment 41 may be a suitably-sized bolt head at the top of rod 38. When handle 40 is removed, instead of using handle 40, a hand held drill (not shown) may be attached to attachment 41, This would allow a user to extend and retract extendible portion 26 using the hand held drill as a power source. Different embodiments may have handle 40 integrally formed or permanently secured to rod 38, or may not include a handle 40. Alternatively, control mechanism 34 may also include its own power source that extends extendible member 22. Referring again to FIG. 2, rod coupling 36 is preferably attached to extendible member 22 by a knuckle joint 42, which allows rotational force to be applied while control mechanism 34 and extendible member 22 pivot relative to each other. In addition, referring to FIG. 3, control mechanism 34 is secured to frame 12 using a bracket 46 that permits axial movement, and some angular movement as well, relative to frame 12. This is to accommodate control mechanism 34 as extendible member 22 pivots, discussed below.

As shown in FIGS. 1 and 2, housing 24 is intended to be pivotally mounted to axle 18 by an axle clamp 44 that is at a midpoint of housing 24, such that housing 24 extends past axle 18 in both directions. Pivoting axle clamp 44 allows frame 12 to be tilted at different angles according to the preferences of the user and the requirements of the situation, while still having extendible member 22 oriented appropriately. Clamp 44 may be designed to pivot in different ways. For example, it may have a fixed portion and a movable portion, where the fixed portion is secured to axle 18, and the movable portion is movable relative to both axle 18 and the fixed portion. The design of clamp 44 will also depend on whether clamp 44 attached directly to axle 18, which will rotate, or to a housing that surrounds axle 18, which would be stationary. Alternatively, clamp 44 may mount extendible member 22 to axle 18, but will be secured to another component, such as by components that extend along axle 18 from frame 12 to secure housing 24 in place.

By mounting extendible member 22 directly to axle 18, the mechanical advantage provided by extendible member 22 is maximized. As the hand truck is lifted or lowered, the balance point of the load is not changed. This keeps the force to lift the load relatively close to being directly under the load throughout the lifting or lowering process. This also improves the safety and reduces the risk of the load being dropped.

Some embodiments may include a hand truck 10 that may be retrofitted with extendible member 22 and control mechanism 34, which may also be installed in a removable manner.

Referring to FIGS. 3 through 6, the use of hand truck 10 to mount stairs 48 will now be discussed. It will be understood that this can be generalized to any vertical obstacle that needs to be overcome. It will also be understood that hand truck 10 may also be used to descend stairs as well, using similar steps in reverse order. As shown in FIG. 1, extendible member 22 is maintained in a preferred orientation by a spring member 23. Referring to FIG. 3, when a stair 48 is encountered, handle 40 is rotated, which in turn rotates rod 38 and rod coupling 36 to actuate extendible member 22 via knuckle joint 42. Extendible portion 26 is moved outward from housing 24 until engagement end 28 engages a surface 50, in this case, a lower step. Referring to FIG. 4, rotating handle 40 more results in extendible portion 26 lifting frame 12 and therefore any load being carried by load-carrying portion 16 upward from surface 50. As extendible portion 26 is not vertically oriented, this frame is also pushed backward slightly to engage the vertical surface of the upper stair 48 being mounted. Once the top of stair 48 is reached, hand truck 10 can be pulled back onto stair 48 as housing 24 of extendible member 22 pivots about axle 18 (shown in FIG. 1). Extendible member 22 can then be safely retracted to its retracted position by rotating handle 40 in an opposite direction, until engagement end 28 is retracted within an outer perimeter of wheels 20. Spring member 23 (shown in FIG. 1) is strong enough to return extendible member 22 to its preferred starting position, but weak enough to allow free movement of extendible member about axle 18 during use. The process can then be repeated as necessary until all stairs have been mounted.

Stairs may be descended by reversing the process described above, where the extendible member 22 is extended until a lower step is reached, and is then retracted until wheels 20 reach that lower step.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. The scope of the claims should not be limited by the preferred embodiments set forth in the examples, but should be given the broadest interpretation consistent with the description as a whole.

What is claimed is:

1. A hand truck with a lifting mechanism, comprising:
a frame having a handle portion, and an load-carrying portion;
an axle supported by the frame, the axle having wheels rotatably mounted to opposed ends of the axle;
an extendible member pivotally mounted to the axle, the extendible member comprising a housing and an extendible portion that extends from the housing, the extendible portion having an engagement end, the engagement end retracting within an outer perimeter of the wheels in a retracted position, and extending outward to engage a ground surface, in the extended position, the extendible member having a length that is greater than a diameter of the wheels;
a control mechanism for selectively extending and retracting the extendible portion.

2. The hand truck of claim 1, wherein the housing of the extendible member is attached to the axle at a midpoint of the housing, such that the housing extends past the axle in two directions.

3. The hand truck of claim 1, wherein the extendible member is screw-actuated and the control mechanism is a rotating body.

4. The hand truck of claim 3, wherein the control mechanism is pivotally connected to the extendible member.

5. The hand truck of claim 4, wherein the control mechanism is pivotally connected to the extendible member by a knuckle joint.

6. The hand truck of claim 4, wherein the control mechanism comprises a hand-operated portion adjacent to the handle portion of the frame.

7. The hand truck of claim 4, wherein the control mechanism comprises an attachment for a drill.

8. The hand truck of claim 4, wherein the control mechanism that is secured to the frame using a bracket that permits axial movement of the control mechanism relative to the frame.

9. The hand truck of claim 1, wherein the extendible end comprises an angled surface, such that the extendible member applies a lifting force that has vertical and horizontal components.

10. The hand truck of claim 1, wherein the extendible end is wider than a width of the extendible member.

11. The hand truck of claim 1, wherein the extendible member is longer than a diameter of the wheels.

12. The hand truck of claim 1, further comprising a spring member for biasing extendible member toward a predetermined position.

13. A lifting mechanism for a hand truck having a frame, an axle, and wheels attached to the axle, the lifting mechanism comprising:
an extendible member comprising a housing, an extendible portion that extends from the housing, the extendible portion having an engagement end, the extendible member having a retracted position and an extended position;
a pivoting axle clamp attached to a midpoint of the housing for attaching to the axle of the hand truck, the distance between the midpoint and the engagement end of the extendible portion in the retracted position being less than a radius of the wheels of the hand truck, and the extendible member having a length that is greater than a diameter of the wheels;
a control mechanism for selectively extending and retracting the extendible portion.

14. The lifting mechanism of claim 13, wherein the extendible member is screw-actuated and the control mechanism is a rotating body.

15. The lifting mechanism of claim 14, wherein the control mechanism is pivotally connected to the extendible member.

16. The lifting mechanism of claim 15, wherein the control mechanism is pivotally connected to the extendible member by a knuckle joint.

17. The lifting mechanism of claim 15, wherein the control mechanism comprises a hand-operated portion.

18. The lifting mechanism of claim 15, wherein the control mechanism comprises an attachment for a drill.

19. The lifting mechanism of claim 15, further comprising a bracket for attaching the control mechanism to a frame of the hand truck that permits axial movement of the control mechanism relative to the frame.

20. The lifting mechanism of claim 13, wherein the extendible end comprises an angled surface, such that the extendible member applies a lifting force that has vertical and horizontal components.

21. The lifting mechanism of claim 13, wherein the extendible end is wider than a width of the extendible member.

22. The lifting mechanism of claim 13, wherein the extendible member is longer than a diameter of the wheels.

23. The lifting mechanism of claim 13, further comprising a spring member for biasing extendible member toward a predetermined position.
